(19) United States
(12) Patent Application Publication
(10) Pub. No.: US 2002/0042265 A1
(43) Pub. Date: Apr. 11, 2002

(54) Automated information entry for wireless devices

(76) Inventors: Amrit Kumaran, Schaumburg, IL (US); Mohammed Ishan, Schaumburg, IL (US); Samir Vaidya, Schaumburg, IL (US)

Correspondence Address: Adam K. Sacharoff, Hamman & Benn, 10 South LaSalle Street, Chicago, IL, 60603, US

(21) Appl. No.: 09/972,732

(22) Filed: Oct. 5, 2001

Related U.S. Application Data
(60) Provisional application No. 60/238,960, filed on Oct. 9, 2000.
(60) Provisional application No. 60/258,368, filed on Dec. 26, 2000.

(51) Int. Cl. H04M 3/42

(52) U.S. Cl. 455/414; 455/435; 455/566

(57) ABSTRACT

A method and system of automated information entry for a wireless device includes receiving a deck from a network. When the deck includes input fields, each input field is replaced with a link to a location containing user defined variables, which creates a modified deck. The modified deck is then transmitted to the wireless device, wherein the link will be displayed within the modified deck on the wireless device. The user selecting one link will access the user defined variables, such that the user may select one of the user defined variables to replace that link. Once completed, the original deck is returned to the wireless device with the user defined variables inserted into the appropriate input fields. The user may then modify any of the input fields or if correct, transmit the original deck, with the input fields filled, back to the network.

CROSS REFERENCE TO RELATED APPLICATIONS

This application claims the benefit of U.S. Provisional Patent Application having Ser. No. 60/238,960 and filed on Oct. 9, 2000 and U.S. Provisional Patent Application having Ser. No. 60/258,368 and filed on Dec. 26, 2000. Both provisional applications are hereby incorporated by reference.

### FIELD OF THE INVENTION

The present invention relates to wireless devices and more particularly to a method and system for entering information into a wireless devices.

### BACKGROUND OF THE INVENTION

Many standard wireless devices, such as cellular telephones, pagers and personal digital assistants (PDA) are Internet connectable and are equipped with special browsers (also referred to as micro-browsers) for viewing web pages on the screens of such devices. Such wireless devices may be enabled such that a user can view web pages or “decks” originally authored in hypertext markup language (HTML), handheld device markup language (HDML), or wireless markup language (WML).

The problem presented to a user browsing or viewing the web pages or decks from the wireless device is the method of entering information. For the devices that include telephone keypads, entering information using the 12-digit telephone keypad is extremely cumbersome and painstakingly difficult. For example, while purchasing a product, if a user had to enter their name as “John Smith,” the user would have to depress the following sequence of keys “566644660777764448,” assuming that the 0 is a space. This is further complicated when the user attempts to input, for example, their billing address mixing numbers and letters.

In addition, wireless devices that incorporate miniature keypads typically require the user to use a pointer or to enter the information carefully as not to accidentally hit additional keys.

In either circumstance, the amount of time that a user spends inputting information, is increased, which in turn increases the overall time that the user is “on-line,” leading to higher monthly charges to the consumer. Furthermore, studies suggest that most users are not likely to carry out “m-commerce” (or even “e-commerce”) transactions when too much typing or entering of information is required to complete the transaction.

As a consequence a need exists for an improved method and system for entering information on a wireless device when connected to the Internet or an intranet. Such a method and system should be independent of the device so that it may be easily employed on any wireless device, such as cellular telephones, pagers and personal digital assistants (PDA), and etc. Such a method and system should further be independent of the network infrastructure such that it would be compatible with current cellular communications networks as well as being fully compatible with current protocol systems to view web pages or “decks” authored in HTML, HDML, or WML.

### SUMMARY OF THE INVENTION

In accordance with the present invention, there is provided a method and system of automated information entry for a wireless device includes receiving a deck from a network. When the deck includes input fields, each input field is replaced with a link to a location containing user defined variables, which creates a modified deck. The modified deck is then transmitted to the wireless device, wherein the link will be displayed within the modified deck on the wireless device. The user selecting one link will access the user defined variables, such that the user may select one of the user defined variables to replace that link. Once completed, the original deck is returned to the wireless device with the user defined variables inserted into the appropriate input fields. The user may then modify any of the input fields or if correct, transmit the original deck, with the input fields filled, back to the network.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a system-level diagram for the automated information entry system for a internet protocol enabled wireless device in accordance with one embodiment of the invention;

FIG. 2 is a functional block diagram of the automated information entry system of FIG. 1 as implemented within a gateway server, in accordance with another embodiment of the invention; and

FIG. 3 is a flowchart of the steps performed by the automated information entry system of FIG. 2 according to one embodiment of the invention.

Corresponding reference characters indicate corresponding components throughout the several views of the drawings.

### DETAILED DESCRIPTION OF THE INVENTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

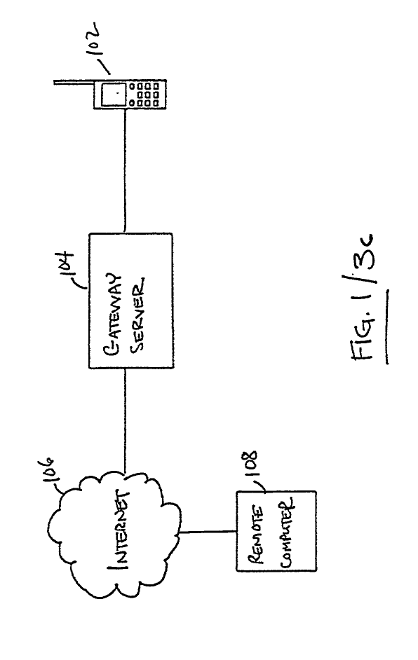

Referring first to FIG. 1 in accordance with one embodiment of the present invention, a system-level diagram is shown for an automated data entry system 100 for a wireless device using an access protocol standard that allows the user to access information from a computer network. As illustrated in FIG. 1, the entry system 100 consists of a wireless device 102, a gateway server 104, a computer network 106 (e.g., the Internet, but may also be any computer network, such as an intranet or local area network), and a remote computer 108. The gateway server 104 is coupled to the computer network 106 and serves as a portal for the wireless device 102 to access the computer network 106.

While the wireless device 102 is depicted throughout the FIGURES as a wireless telephone, it should be fully appreciated that the term wireless device 102 may also signify any wireless device such as, but not limited to: pagers, two-way radios, smartphones, cellular telephones or personal digital assistants (PDA). Since, as mentioned above, the wireless devices 102 are capable of being connected to a computer network 106 the device are typically enabled with an access protocol standard, such as with the Wireless Access Protocol (WAP). This permits the user to view web pages or “decks” on the screens of such devices through special browsers (also referred to as microbrowsers). The access protocol standard permits the viewing of web pages originally authored in hypertext markup language (HTML), handheld device markup language (HDML), or wireless markup language (WML).

A telephone service provider through the gateway server 104 provides the network services. The service provider is commonly a wireless service provider. Moreover, the present invention is independent of the network infrastructure such that it would be compatible with current cellular communications networks, such as but not limited to: Radio Frequency (RF) networks, Advanced Mobile Phone System (AMPS), Total Access Communication System (TACS), Nordic Mobile Telephone (NMT), Personal Digital Cellular (PDC) and Personal Handyphone System (PHS), Global System for Mobile Communications (GSM) and General Packet Radio Service (GPRS), Integrated Dispatch Enhanced Network (iDEN), Digital European Cordless Telecommunication (DECT), Terrestrial Trunked Radio (TETRA), Mobitex, IS-136 or other Time Division Multiple Access (TDMA) networks, IS-95 or other Code Division Multiple Access (CDMA) networks, Cellular Digital Packet Data (CDPD) networks, 3G networks, and satellite networks; as well as being fully compatible with DataTAC, and FLEX, ReFLEX. The gateway server 104 is a portal to the computer network 106 for the wireless device 102.

As further mentioned above, one common problem given that a user may browse these web pages is the method of information entry. For wireless devices that incorporate miniature keypads, the method of entering information requires the user to use a pointer or to enter the information carefully as not to accidentally hit additional keys. For wireless devices that include telephone keypads, entering information using the 12-digit telephone keypad is extremely cumbersome, as the user must painstakingly press many buttons for the entry of simple text. For example, while purchasing a product, if a user had to enter their name as “John Smith,” the user would have to depress the following sequence of keys “566644660777764448,” assuming that the 0 is a space. This is further complicated when the user attempts to input, for example, their billing address mixing numbers and letters. This increases the amount of time that a user spends inputting information, which increases the overall time that the user is “on-line”, leading to higher monthly charges to the consumer. Furthermore, studies suggest that most users are not likely to carry out “m-commerce” (or even “e-commerce”) transactions when too much typing or entering of information is required to complete the transaction.

In one embodiment of the invention, an automated information entry system is provided that significantly reduces the amount of typing or physical entering the user must perform on the wireless device 102. According to one embodiment, the automated information entry system is implemented within the gateway server 104, although may be implemented in other portal sites or proxy servers within the computer network 106, such as at the remote computer 108. As such, with respective to the wireless device 102, the automated information entry system is a server-side solution implemented at the gateway server 104, as opposed to a client-side solution implemented at the wireless device 102.

Generally, according to one embodiment of the invention, the user first logs into the gateway server 104, which allows the user to enter information, such as name, address, phone number, credit card number, passwords, commonly used phrases, etc. The automated information entry system generates user variables deck specifically for use by the user, which includes cards that contain the information entered by the user. This information is stored in the gateway server 104 as a deck, not stored within the wireless device 102. Alternatively, depending on the system, the gateway server 104 may store the information within a web page or simply store it in a database.

At this point, the user begins to browse the computer network 106 by requesting a uniform resource locator (URL), which is transferred from the gateway server 104 to the website in the computer network. In response to this request, a deck or web page is then received into the gateway server 104 from the website. The gateway server 104 then parses the received deck or web page and determines if there are any input fields present. An input field is a location on the deck or web page in which information may be entered. If there is an input field, a link to the stored user variables deck is added to a copy of the received deck or web page. Thus, the received deck or web page is stored unmodified but is also modified to include the link or links to the user variables deck. The modified deck (or web page) is then transmitted as normal to the wireless device 102 for the user to view, in place of the originally received deck or web page. When the user views the deck, the user will have the option of highlighting or clicking on the link added to the input fields. For example, if the input field asks for users address, the user selects the link within the address input field. The gateway server 104 then sends the user variables deck to the wireless device 102 so that the use can select the appropriate information (e.g., the address) from the user variables deck. The automatic information entry system then retrieves the stored information from the user variables deck and inserts it into the input field of the original deck (or web page). This original deck including the selected information from the user variables deck is then sent to the wireless device 102 for the user to view. Thus, the information is entered into the deck without the user having to manually type in the information. The user may revise the deck including the information automatically entered into the input field if desired. Then, once satisfied, the user sends the deck (or web page) back to the gateway server 104, which passes it to the host server in a suitable form. Advantageously, the user does not have to type anything for the entry of information in the input field, since this information is already stored in the gateway server 104. Advantageously, valuable memory space is not consumed at the wireless device 102 for either the storage of information or for the software to execute the automated information entry system. The following is a more detailed description.

The information may be any information desired by the user. For example, the user may input several phrases for storage in the gateway server 104. For example, the user inputs the phrase, “It was nice hearing from you, lets chat later.” This is then stored in the user variables deck as “goodbye phrase.” If the user requests a chat page that includes an input field that the user may type anything within, the user may type a short message and then select the link inserted by the automated information entry system. Upon the selection, the user receives the user variables deck and is prompted to select among several types of stored information and selects the “goodbye phrase.” The original deck (i.e. the copied unmodified received deck or web page) is then resent back to the user with the goodbye phrase automatically inserted within the deck. Again, the user did not have to physically type the phrase, which in the case of typing on a telephone keypad saves considerable typing efforts.

It is noted that the automated information system may apply in the context of a regular computer using a regular browser coupled to a portal site and not necessarily at a gateway server 104. For example, the user may be able to easily type in the information into a web page being viewed using a keyboard. However, the user may not know or remember the information to be entered. As such, whenever an input field is detected, a link to the stored information is placed within the web page. The user may select the link and receive a web page containing the information that user has stored. The user selects the appropriate information that is automatically inserted and sent back to the wireless device 102 for confirmation.

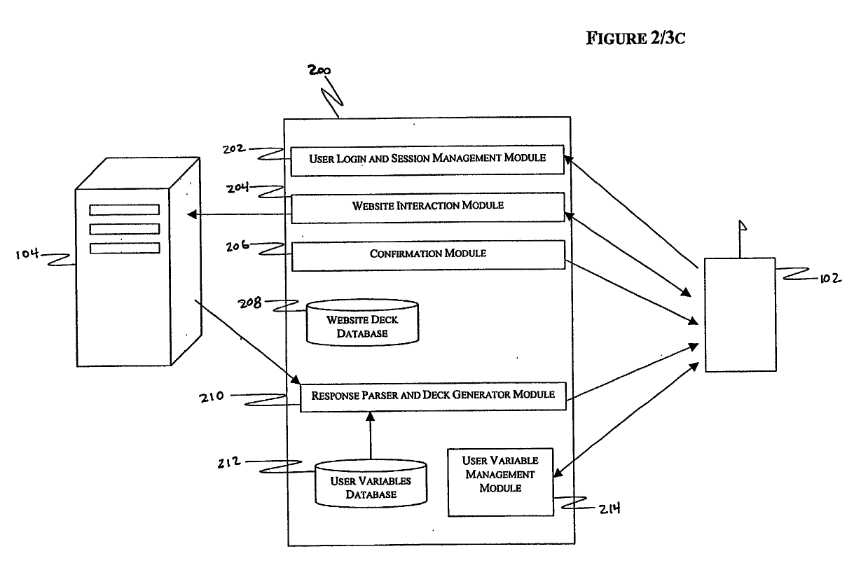

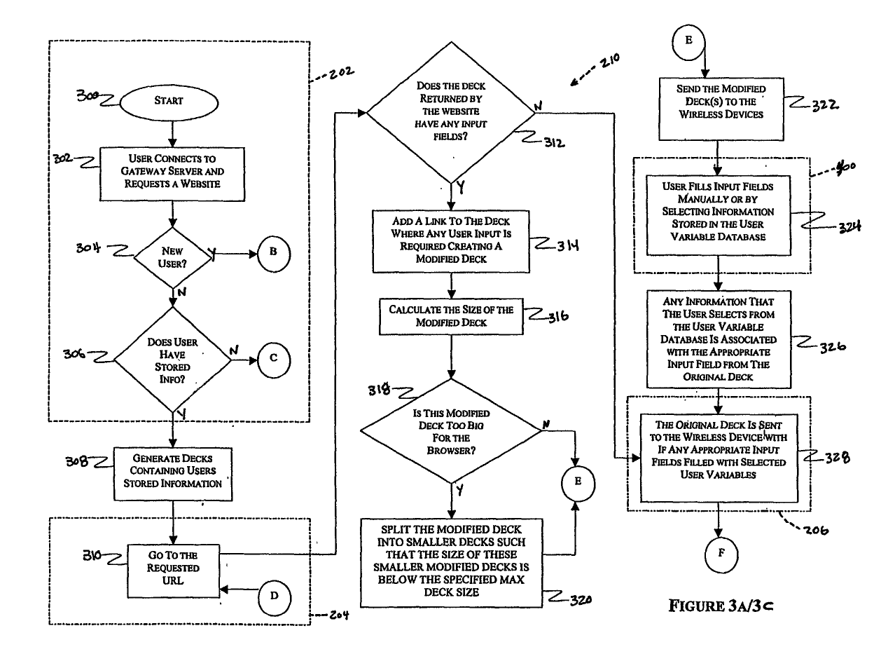

Referring next to FIG. 2, a functional block diagram is shown of the automated information entry system of FIG. 1 as implemented within a gateway server 104, in accordance with another embodiment of the invention. The automated information entry system 200 of FIG. 2 is implemented within the gateway server 104 and is specifically designed to operate in conjunction with the wireless device 102, which is preferably access protocol enabled. The automated information entry system 200 includes a user login and session management module 202, a website interaction module 204, a confirmation module 206, a response parser and deck generator module 210, a user variables management module 214, a website deck database 208, and a user variables database 212.

The User Login and Session Management Module 202, presents the user with a login menu upon contact with the gateway server 104. The user enters their login information, which is sent to the User Login and Session Management Module 202. If no problems are found a session is created for the user. In some systems, for example, if the automated information entry system is implemented at the cellular service provider, the user may not have to login, since the gateway server can identify the user by the phone number of the incoming call and automatically initiate a session. Furthermore, in some embodiments, the user may login in from a remote computer 108 coupled to the gateway server 104 via the computer network 104.

The User Variables Management Module 214 is accessed from the main page of the automated information entry system. It provides a method for the user to add, edit and delete any information that the user wishes to store in the User Variables Database 212. For example, the user might store their name, login id, password, billing address, shipping address, credit card number, clothing sizes, height, weight, phrases, etc. This user variables database 212 is used to generate a user variables deck containing the user's frequently used information. Alternatively, since entering information is time intensive using the normal entry device, such as the telephone keypad or miniature keyboard, the information may be entered using a remote computer 108 accessing the main page of the automated information entry system 200.

Once a session is created, control passes to the website interaction module 204. The website interaction module 204 presents the user with a method to enter the URL of the website the user would like to visit. Once the URL has been entered, the website interaction module 204 contacts the website and requests the user entered URL.

The Response Parser and Deck Generator Module 210 receives the response from the website, either in the form of a deck or a web page. It is noted that prior to receipt of the web page, the response parser and deck generator module 210 has already generated a user variables deck containing the users frequently used variables or information from the user variable database 212. After receipt of the web page from the website, the entire received web page (or received deck) is stored in the website deck database 208. The system then parses any input fields in the web page (or deck) and stores the variables associated with those input fields in the website deck database 208. The input field may be a location on the web page (or deck) where the user may enter information, such as an address, etc. The parser then inserts a link to the user variables deck containing the users frequently used variables wherever it finds any input fields. Next, the parser replaces all the links in the received web page (or deck) with links that the Website Interaction Module 204 can use. Finally the parser generates a new web page (or deck) including the link or links and sends the modified web page to the wireless device 102.

The response parser and deck generation module 210 will also make sure that any modifications that it makes to the deck are made in such a way that the size of the deck does not surpass the industry specified maximum size of decks (which currently happens to be approximately 1400 bytes for WAP). In the case that the deck is larger than this specified value, the response parser and deck generation module 210 will split the deck into multiple decks (e.g. 2 decks) and add a link in the first deck to the second deck and so on.

At the client side, i.e. the wireless device, the user can select the inserted link within the input field containing the users variables to fill in any input fields in the deck (or web page) received at the wireless device without having to physically type in the information. If the user clicks on or selects a link or button that requires any interaction with the website that originally sent the deck or web page to the gateway server 104, control is passed back to the website interaction module 204. Otherwise the system allows the user to select the store user variables and insert them into the deck or web page. A more detailed description of the specific process at the response parser and deck generation module 210 is discussed below.

In some embodiments, the Confirmation Module 206 is used to display to the user the original deck (or web page) with the selected input fields filled in (by the automated information entry system) before anything is submitted to the website. Thus, the user may manually revise the automatically entered information.

Advantageously, the automated information entry system 200 is implemented at the server side, rather than the client side, since the client side has limited memory and resources to host such a system. Furthermore, the user could take advantage of the automated information entry system on another user's telephone, assuming that the other individual used the same service provider/gateway server and the user has a way to login, since the system is implemented at the server side, not the client side.

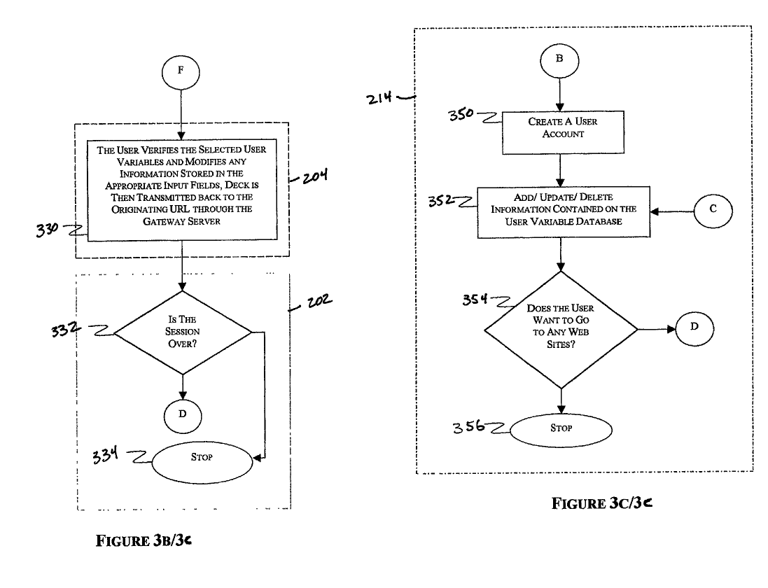

Referring next to FIGS. 3A through 3C, a flowchart of the steps performed by the automated information entry system of FIG. 2 is shown according to one embodiment of the invention. Additionally, the specific functional modules of the automated information entry system 200 of FIG. 2 will be referenced within this flowchart.

Upon starting a session (step 300) a user of the access protocol enabled device, e.g. wireless device 102 connects to the service provider's gateway server 104 and requests a website by entering a URL or by selecting a bookmark (step 302). The system determines if the user is a new user (step 304). If the user is new (step B), then the system will create a user account for the new user (step 350). The user is then given the option to enter any information that the user would like to be stored by the automated information entry system (step 352). For example, the user may enter the user's name, address, and password. This information is stored in the user variables database 212. Then the user can decide on whether they want to go to a website (step 354). If the user does not want to go to a website at this time (step 354), then the session is terminated (step 356). For example, the user may simply be signed on to add or edit stored information only, not to browse the web. If the user would like to go to a website (step 354), then the user inputs a URL and the system proceeds (step D) as described below.

If the user is not new (step 304), then the system determines if the user has any stored information or variables (step 306), e.g., in the user variables database 212. If the user does not have any stored information (step c), then the user is presented with the opportunity to enter whatever information the user desires to be stored (step 352) and then proceeds to step 354 (as described above).

If the user has stored information (step 306), then the response parser and deck generation module 210 generates one or more decks containing the users stored information (step 308), for example, the user variables deck(s) (or web pages(s)) is created. This user variables deck is stored, for example, in the user variables database 212. When referring to this flowchart and throughout, it is noted that according to an access protocol, a deck is a representation of a web page and includes one or more cards. The cards are viewed on the screen of the wireless telephone. In most access protocols decks are limited to a size of approximately 1400 bytes so if the deck exceeds that size another deck is created. According to the access protocol, web pages received at the interface (i.e., the gateway server 104) can be converted to one or more decks so that the microbrowser of the enabled wireless device 102 can view the web page. Alternatively, the wireless device 102 may be embodied as a device having a browser capable of viewing a web page; thus, reference is made to decks or web pages.

Next, the automated information entry system requests the desired URL from the website of the computer network (step 310). The requested web page is received at the automated information entry system of the gateway server 104. While the received web page is preferably a viewable deck, it may also be in WML, in HTML or HDML, and converted to one or more viewable decks, preferably the viewable deck is WML, however, other standards may be appropriate. Next, the received deck is checked to see if it contains any input fields (step 312). This is done by parsing the received deck (or web page) and looking for input fields. Thus, the automated information entry system determines if there are any input fields present in the received deck (or web page).

If there are no input fields in the received deck or web page (step 312), then the original deck (or web page) that was received from the website is sent to the wireless device 102 unmodified for display (step 328). On the other hand, if one or more input fields are detected (step 312), then a link to the user variables deck is added to the received deck or web page for each input field (step 314). Thus, the deck (or web page) that was received at the gateway server 104 is modified with the addition of one or more links to the stored user variables deck that contains the user variables or user information. Furthermore, a copy of the received deck (or web page), without the added links, is stored in the gateway server 104 for later use.

Next, since the deck has been modified, the size of the modified deck is calculated (step 316). Once calculated, a determination is made if the size of the modified deck is too big for the particular microbrowser utilized by the wireless device at the client side (step 318). This is done by comparing the size of the modified deck to the predefined maximum size allowed by the access protocol. If the modified deck is not too big (step E), then the modified deck (or web page) is sent to the wireless device 102 (step 322). In other embodiments using a regular browser, not a microbrowser, the modified web page is sent to the wireless device (step 322), while a copy of the original web page is maintained at the gateway server 104.

If the deck is too big for the browser (step 318), then the modified deck is split into smaller decks so that each of the smaller decks are smaller than the specified maximum deck size (step 320). Then, the system sends the modified decks to the wireless device, step E to step 322.

At the client side, i.e., at the wireless device 102, the user views the modified deck one card at a time, and fills any input field either manually or by selecting the link or links to the user variables deck (step 324). This step is performed at a user/web browser module 400 in the wireless device 102. The manual entry is accomplished by painstakingly typing in the appropriate information. This problem is avoided by the user selecting or clicking on the appropriate link in the modified deck (or web page) on the user's display. Again, the link is to the user variables deck stored in the gateway server 104 that contains the users commonly used variables or information. As such, the system then sends the user variables deck (or web page) to the wireless device such that the user can view the user variables deck and highlight or select the appropriate information to be entered into the input field. Thus, the user can view all of the stored information and choose which information shall go into the selected input field. Once selected, the information that the user selects from the user variables deck is associated with the appropriate input field in the original deck or web page that was received from the website (step 326), i.e. the unmodified copy of the deck or web page received from the website without the added links.

The next step is that the automated information entry system sends the original deck (or web page) to the wireless device 102, but including any of the information selected by the user (step 328) that was stored in the user variables deck (or web page). Thus, the original deck appears on the screen of the wireless device 102 with the information stored inserted into the input field. This serves the purpose of user verification (step 330 from step F). For example, the user gets to view the original deck without links and including the inserted information for accuracy. Next, the user modifies any information in any of the input fields if desired and once the user is satisfied, the user transmits the deck (or web page) back to the originating website (step 330) via the gateway server 104.

At this point, if the user is done browsing and wants to end the session (step 332), the session is terminated step 334 otherwise step 310 (from step D) is repeated as necessary. For example, the user will enter another URL and the gateway server 104 will retrieve the next URL requested and so on.

As can be seen, the user login and session management module 202 performs steps 300 through 306 and 332 through 334; the response parser and deck generation module 210 performs steps 308, 312 through 322, and 326; the website interaction module 204 performs steps 310 and 330; the confirmation module 206 performs step 328; the user variables module 214 performs steps 350 through 356; and the user/web browser module 400 performs step 324.

As such, by providing a remote location for the user to store information, and inserting a link to this information in the decks or web pages transmitted to the wireless device, a method is provided for the automatic entry of the information from the wireless device 102 without having to physically enter the information at the wireless device 102, by typing on the telephone keypad.

Furthermore, by conveniently locating the automated information entry system at the gateway server 104, valuable memory and processing are not used up at the client device. Furthermore, the system is transparent to the various websites at other remote servers that make up the computer network 106. These websites are not required to belong to or subscribe with the server that hosts the automated information entry system (e.g., the gateway server). The websites simply transmit requested decks or web pages as normal without any knowledge that their decks are being modified at a portal site, e.g., the gateway server 104. Thus, from the view of the website server, the solution appears to be client-side; however, from the view of the wireless device, the solution is a server-side solution.

By advantageously providing the automated information entry system at the gateway server the system is easily implemented. For example, the system is not implemented at the respective websites making up the computer network, nor is the system implemented in the individual clients. As such, current client devices and web servers are not altered in any way only the portal type server, e.g., the gateway server 104, is modified with the addition of the automatic information entry system.

In an alternative embodiment, the system may be implemented at another website or server within the computer network (e.g. at the remote computer 108); however, in order to take advantage of the system, a user must access the particular server providing the system. For example, that particular server becomes a portal to the rest of the computer network 106, as opposed to the gateway server 104, which is already a portal.

In yet another embodiment of the present invention a advertisement deck may be sent to the wireless device along with the modified deck, which includes the links to input fields. The advertisement deck would also contain an ad-link, not to the user variables deck, but it may be linked to another website. The user selecting the ad-link would then request another or new URL, which the system would then follow from step 310 above. The advertisement deck may simply be a flash deck, which would pop up on the microbrowser or regular browser, depending upon the wireless device 102 being used. The flash deck would simply show an advertisement to the user and then place the ad-link in the user's variables deck, which the user could select or delete at a later time. Moreover, to become less obtrusive to the user, the advertisement decks could be screened depending upon the users preferences or prior searches. For example, if the user previously requested the URL of a search engine and created a search request of “cats.” The information may be stored temporarily such that an advertisement deck that related to “cats” would be flashed on the wireless device 102. As such, advertisement decks would be specifically targeted to the current user and implemented unobtrusively.

In yet another embodiment of the present invention, the system may also create a history deck of all the user's previously visited URLs. When the user starts a session, the user can be prompted to view the history deck, such that the user can easily go to any previously requested URL. In addition the system may also store or create bookmarks. It is further important to note that these decks, history, bookmarks, advertisement decks are not stored on the client side (at the wireless device) but stored at the gateway server 104, such that the wireless device does not face any problems storing such information.

It is noted that one of skill in the art could easily design the software necessary to implement such a system; thus, no further explanation is provided.

While the invention herein disclosed has been described by means of specific embodiments and applications thereof, numerous modifications and variations could be made thereto by those skilled in the art without departing from the scope of the invention set forth in the claims.

1. A method of automated information entry comprising:
receiving a deck or a web page including one or more input fields from a server;
detecting the presence of the one or more input fields;
inserting a link into the one or more input fields, wherein the link is to a location containing user defined variables; and
transmitting the deck or the web page to a client device, wherein the link will be displayed within the deck or the web page on the client device.

2. The method of claim 1 further comprising storing the received deck or web page unmodified.

3. The method of claim 2 further comprising receiving a request to access the location containing the user defined variables.

4. The method of claim 3 wherein the location comprises a user variables deck or web page.

5. The method of claim 4 further comprising transmitting the user variables deck or web page to the client device.

6. The method of claim 5 further comprising inserting a selected one or more of the user defined variables from the user variables deck or web page into respective ones of the one or more input fields of the unmodified deck or web page.

7. The method of claim 6 further comprising transmitting the unmodified deck or web page including the selected one or more of the user defined variables having been inserted to the client device.

8. The method of claim 3 further comprising inserting a requested portion of the user defined variables into the unmodified received deck or web page into a respective one of the one or more input fields.

9. The method of claim 8 further comprising transmitting the unmodified deck or web page containing the requested portion of the user defined variables to the client device.

10. The method of claim 1 wherein the client device comprises a wireless device.

11. The method of claim 10 wherein the wireless device is access protocol enabled.

12. A system of automated information entry comprising:
a means for requesting a web page on a network through a gateway server from a wireless device;
a means for retrieving said web page from said network and storing said retrieved web page on said gateway server;
a means for modifying the web page by replacing each input field with a link to a location on said gateway server containing a predefined variables page, when said web page includes an input field, creating a modified web page, wherein said predefined variables page includes at least one predefined variable;
a means for transmitting the modified web page from the gateway server to the wireless device such that when transmitted the modified web page is displayed on said wireless device;
a means for retrieving said predefined variables page from the gateway server to the wireless device such that the predefined variables page is also displayed on said wireless device, when a link is selected;
a means for selecting at least one of said at least one predefined variable, from the predefined variables page, and a means for associating said selected predefined variable to said selected link thereby associating the selected predefined variable with the input field corresponding to the selected link;
a means for transmitting to the network the retrieved web page with any selected predefined variables appropriately associated with the input fields corresponding therewith.

13. A system of automated information entry for a wireless device comprising: a means for receiving a first deck from a network;
when the first deck includes input fields, a means for replacing each input field with a link to a location containing predefined variables, creating a modified first deck;
a means for transmitting the modified deck to the wireless device, wherein the link will be displayed within the modified deck on the wireless device;
a means for selecting one of the links which accesses the predefined variables, such that when one of the predefined variables is selected said selected predefined variable replaces said one link; and
a means for transmitting to said network the first deck with any input fields replaced with the selected predefined variables.

14. The system of claim 13 further comprising a means to verify and modify any predefined variables selected to replace said links.

15. The system of claim 13 further comprising a means for tracking the decked received from the network creating a history of decks.

16. The system of claim 13 further comprising a means for creating advertisement decks.

17. The system of claim 13 further comprising a means for defining and modifying the predefined variables from the wireless device.

18. The system of claim 13 wherein the network is selected from one or more of the following: Radio Frequency (RF) networks, Advanced Mobile Phone System (AMPS), Total Access Communication System (TACS), Nordic Mobile Telephone (NMT), Personal Digital Cellular (PDC) and Personal Handyphone System (PHS), Global System for Mobile Communications (GSM) and General Packet Radio Service (GPRS), Integrated Dispatch Enhanced Network (iDEN), Digital European Cordless Telecommunication (DECT), Terrestrial Trunked Radio (TETRA), Mobitex, IS-136 or other Time Division Multiple Access (TDMA) networks, IS-95 or other Code Division Multiple Access (CDMA) networks, Cellular Digital Packet Data (CDPD) networks, 3G networks, and satellite networks.

19. The system of claim 13 wherein the wireless device incorporates an access protocol standard permitting the viewing of decks originally authored in hypertext markup language (HTML), handheld device markup language (HDML), or wireless markup language (WML).

20. The system of claim 19 wherein the access protocol is Wireless Access Protocol (WAP).
